(19) United States
(12) Patent Application Publication
(10) Pub. No.: US 2026/0298720 A1
(43) Pub. Date: Oct. 1, 2026

(54) Downrigger Probe

(71) Applicant: Airmar Technology Corporation, Milford, NH (US)

(72) Inventors: Eric J. Beiswenger, Amherst, NH (US); Bruno Marie, Ploemeur (FR); Baptiste Verneau, Clohars (FR)

(21) Appl. No.: 19/477,707

(22) PCT Filed: May 22, 2024
(86) PCT No.: PCT/US2024/030527

§ 371 Date: Oct. 22, 2025

Related U.S. Application Data
(60) Provisional application No. 63/503,652, filed on May 22, 2023.
(60) Provisional application No. 63/582,947, filed on Sep. 15, 2023.

(51) Int. Cl. G01J 5/60; A01K 91/08; G01P 5/07; G01S 17/88; H04B 11/00; H04B 13/02; H04R 1/04; H04R 1/44; H04R 17/00

(52) U.S. Cl. CPC G01J 5/60; A01K 91/08; G01P 5/07; G01S 17/88; H04B 11/00; H04B 13/02; H04R 1/04; H04R 1/44; H04R 17/00

(57) ABSTRACT

A downrigger probe and corresponding method and system may be used for fishing. The downrigger probe comprises at least one processor and at least one sensor coupled to the at least one processor. The at least one sensor includes a sensor that senses colors in water around the downrigger probe. The at least one processor transforms respective values of the colors sensed into an ambient color temperature of the water around the downrigger probe. The downrigger probe transmits the ambient color temperature, acoustically through the water. For non-limiting example, such ambient color temperature may be useful toward selection of a lure for the fishing.

### RELATED APPLICATIONS

This application claims the benefit of U.S. Provisional Application No. 63/503,652, filed on May 22, 2023 and U.S. Provisional Application No. 63/582,947, filed on Sep. 15, 2023. The entire teachings of the above applications are incorporated herein by reference.

### BACKGROUND

A downrigger is a device typically used when trolling for fish below a surface. The downrigger is used to keep lures or bait at a specific depth while a fishing boat (vessel) is moving. For non-limiting example, a downrigger typically includes four major components, namely a weight, cable, pole or boom, and a spool. A fishing line may be attached to the downrigger cable (line) by means of a “line release.” The weight is typically a five-to-twenty-pound mass of lead which is connected to a stainless-steel cable for non-limiting example. The spool may be controlled either by a manual crank or via an electric motor.

In addition to attaching a lure to the fishing line, an oval piece of metal or plastic is often used to attract fish from greater distances. Such a piece is typically called a “dodger” or “flasher,” and is often hammered or curved for reflective purposes. The types of lures used for trolling with downriggers range from metal “spoons,” that are often decorated using color tape or paint, plastic or rubber “squids,” tinsel beaded flies, or painted plastic J-plugs for non-limiting examples. Such lures typically come in a variety of colors, finishes, and glow patterns for various fishing conditions.

A length of the fishing line between the downrigger release and the lure is known as the “lead,” which typically varies in length depending on how far behind the boat a fisherman on the boat would like the lure to trail. This fishing line is typically between ten- and twenty-pound test for non-limiting example. When fishing for salmon, this lead is often quite lengthy in order to avoid frightening the fish with the noise of the boat's trolling motor.

A speed at which the lure is pulled through the water may have an impact on fishing success or failure. For this reason, fishermen use devices that accurately track speed. Typically, trolling from one to five knots is a non-limiting example range that allows for fish to be caught. Such a target speed for trolling may, however, vary from species to species.

The downrigger is typically set at a depth at which the target fish are schooling. Different species of fish school at different depths, and those depths also change at different times of year. A fish finder may be useful for determining the depth.

### SUMMARY

According to an example embodiment, a downrigger probe for fishing comprises at least one processor and at least one sensor coupled to the at least one processor. The at least one sensor includes a sensor configured to sense colors in water around the downrigger probe. The at least one processor is configured to transform respective values of the colors sensed into an ambient color temperature of the water around the downrigger probe. The downrigger probe is configured to transmit the ambient color temperature, acoustically through the water.

The colors sensed may be RGB colors. The sensor of the downrigger probe may be a device configured to sense ambient light, sense the RGB colors, and perform proximity detection for non-limiting examples. The respective values of the colors may be RGB values of the colors sensed. The device may be coupled to the at least one processor of the downrigger probe via a digital bus. The device may be configured to transmit the RGB values to the at least one processor via the digital bus.

The downrigger probe may have a tail and the sensor may be located at the tail.

The downrigger probe may further comprise a line attachment configured to attach the downrigger probe to a downrigger line. The line attachment may be a metal bridle for non-limiting example.

The respective values of the colors may be RGB values. To transform the respective values of the colors sensed into the ambient color temperature, the at least one processor may be further configured to convert the RGB values to Commission Internationale de l′Elcairage (CIE) tristimulus values, compute normalized chromaticity values based on the CIE tristimulus values, and compute the ambient color temperature based on the normalized chromaticity values computed. The ambient color temperature computed may be expressed in Kelvin.

The downrigger probe may further comprise a power amplifier stage and a piezoceramic element. The at least one processor may be further configured to generate an electrical signal representing the ambient color temperature. The power amplifier stage may be configured to amplify the electrical signal generated. The piezoceramic element may be configured to transform the electrical signal generated and amplified into an acoustic signal. The downrigger probe may be further configured to transmit the acoustic signal to transmit the ambient color temperature, acoustically, through the water.

The sensor may be a color-and-proximity sensor configured to emit light, sense reflected light that is reflected in response to the light emitted, and output a proximity measurement based on the reflected light sensed. The proximity measurement may be affected by particles in the water and may include a near proximity measurement and a far proximity measurement. The at least one processor may be further configured to determine a level of turbidity in the water based on the near proximity measurement and the far proximity measurement and to generate an electrical signal representing the level of turbidity determined.

The power amplifier stage may be configured to amplify the electrical signal generated. The piezoceramic element may be configured to transform the electrical signal generated and amplified into an acoustic signal. The downrigger probe may be further configured to transmit the acoustic signal to transmit, acoustically through the water, the level of turbidity determined.

The downrigger probe may further comprise a magnetic paddlewheel. The at least one sensor may further include a Hall effect sensor configured to sense magnetic field changes generated by rotation of the magnetic paddlewheel and to output a Hall effect sensor signal based on the magnetic field changes sensed. The at least one processor may be further configured to determine a speed of the water around the downrigger probe based on the Hall effect sensor signal output and to transmit, acoustically through the water, the speed determined.

A frequency of the Hall effect sensor signal output may be based on a rotation speed of the magnetic paddlewheel. The rotation speed may be affected by the speed of the water. The at least one processor may be further configured to determine the frequency of the Hall effect sensor signal output and to determine the speed of the water based on the frequency determined and a conversion coefficient for the downrigger probe.

The downrigger probe may further comprise at least one memory coupled to the at least one processor and an inertial measurement unit (IMU) sensor. The at least one memory may include a lookup table. The IMU sensor may be configured to measure a tilt angle of the downrigger probe. The at least one processor may be further configured to select the conversion coefficient from the lookup table based on the tilt angle measured and to determine the speed of the water based on the frequency determined and the conversion coefficient selected.

The at least one processor may be further configured to generate an electrical signal based on the speed determined. The power amplifier stage may be configured to amplify the electrical signal generated. The piezoceramic element may be configured to transform the electrical signal generated and amplified into an acoustic signal. The downrigger probe may be further configured to transmit the acoustic signal to transmit, acoustically through the water, the speed determined.

The at least one sensor may further include a pressure sensor configured to sense pressure applied to the downrigger probe. The at least one processor may be further configured to change an operating state of the downrigger probe based on the pressure sensed. In an event the pressure sensed is below a first threshold, the at least one processor may be further configured to cause the downrigger probe to stop transmitting data, acoustically, and to enter a standby state that limits processing to reduce power consumption. In an event the pressure sensed is greater than a second threshold, the at least one processor may be further configured to cause the downrigger probe to change the operating state from the standby state to an active state in which acoustic transmission is enabled and processing is not limited.

The at least one processor may be further configured to configure a configurable uplink frequency parameter for an acoustic link based on configuration information input to the downrigger probe. The downrigger probe may be further configured to transmit the ambient color temperature via the acoustic link based on the configurable uplink frequency parameter configured.

The at least one sensor may further include a temperature sensor configured to sense temperature of the water around the downrigger probe. The downrigger probe may be further configured to transmit, acoustically through the water, the temperature sensed.

The downrigger probe may further comprise a charging coil and a battery. The charging coil may be configured to charge the battery of the downrigger probe, wirelessly.

According to another example embodiment, a method comprises sensing colors in water around a downrigger probe via a sensor of at least one sensor of the downrigger probe. The at least one sensor is coupled to at least one processor of the downrigger probe. The downrigger probe is used for fishing. The method further comprises transforming, by the at least one processor, respective values of the colors sensed by the sensor into an ambient color temperature of the water around the downrigger probe and transmitting, by the downrigger probe, the ambient color temperature acoustically through the water.

Further alternative method embodiments parallel those described above in connection with the example downrigger probe embodiment.

According to another example embodiment, a system for fishing comprises a downrigger probe fixed on a downrigger line being trolled by a vessel. The system further comprises a processor box configured to communicate with the downrigger probe via a hydrophone. The downrigger probe is configured to sense colors in water around the downrigger probe, transform respective values of the colors sensed into an ambient color temperature of the water, and transmit the ambient color temperature acoustically through the water to the processor box via the hydrophone. The processor box is configured to cause a representation of the ambient color temperature transmitted to be output to a user device.

Further alternative system embodiments parallel those described above in connection with the example downrigger probe embodiment.

It should be understood that example embodiments disclosed herein can be implemented in the form of a method, apparatus, system, or computer readable medium with program codes embodied thereon.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A-1 is a schematic diagram of an example embodiment of a system for downrigger fishing.

FIG. 1A-2 is a block diagram of an example embodiment of rigging within the system of FIG. 1A-1.

FIG. 1B is a schematic diagram of an example embodiment of the system of FIG. 1A-1.

FIG. 2 is a block diagram of an example embodiment of components of a downrigger probe.

FIG. 3 is a block diagram of an example embodiment of components of a processor box.

FIG. 4 is an image of an example embodiment of an overall shape of a downrigger probe body.

FIGS. 5A-D are views of example embodiments of the downrigger probe of FIG. 4.

FIG. 6 is a block diagram of an example embodiment of a signal output from a Hall effect sensor.

FIG. 7 is a timing diagram of an example embodiment of the signal of FIG. 6.

FIGS. 8A and 8B are views of an example embodiment of a tilt effect of a downrigger probe.

FIG. 9. is a timing diagram of an example embodiment of an electrical signal that may represent water speed.

FIG. 10 is a schematic diagram of an example embodiment of a device of a downrigger probe.

FIG. 11 is a graph of an example embodiment of a color gradient.

FIG. 12 is a schematic diagram of an example embodiment of a device of a downrigger probe detecting particles.

FIGS. 13A-C are images of an example embodiment of a trial for turbidity measurement.

FIG. 14 is a graph of an example embodiment of proximity measurement data.

FIG. 15 is an image of an example embodiment of pressure thresholds.

FIG. 16 is a flow diagram of an example embodiment of a method.

FIG. 17 is a block diagram of an example internal structure of a computer optionally within an embodiment disclosed herein.

### DETAILED DESCRIPTION

A description of example embodiments follows.

An example embodiment of the disclosure herein relates to a downrigger probe that may be employed, advantageously, for downrigger fishing.

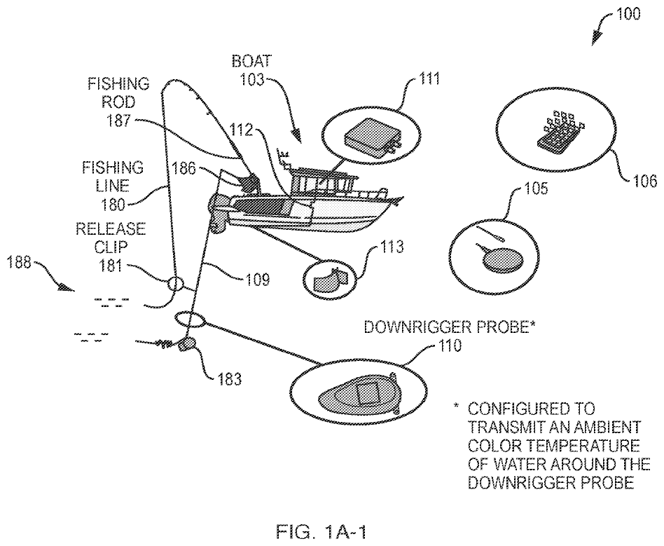

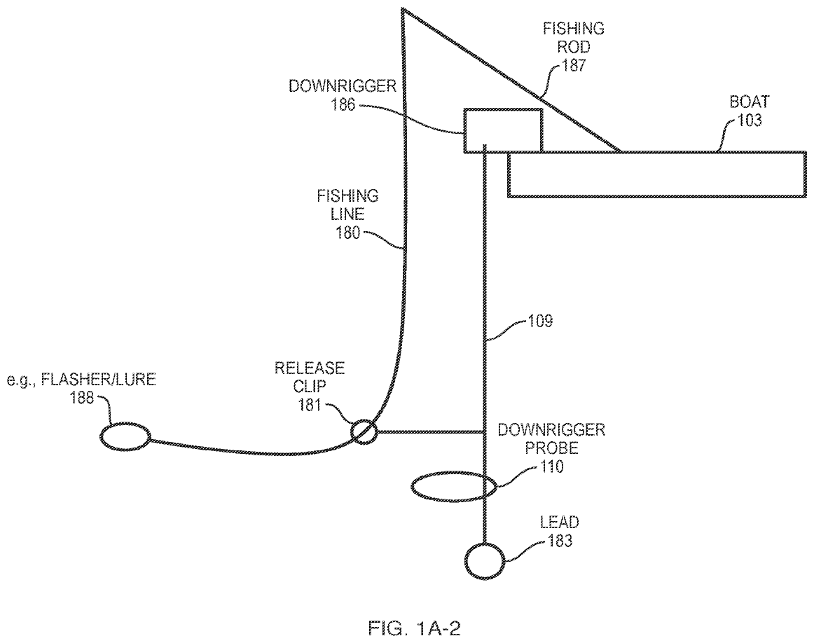

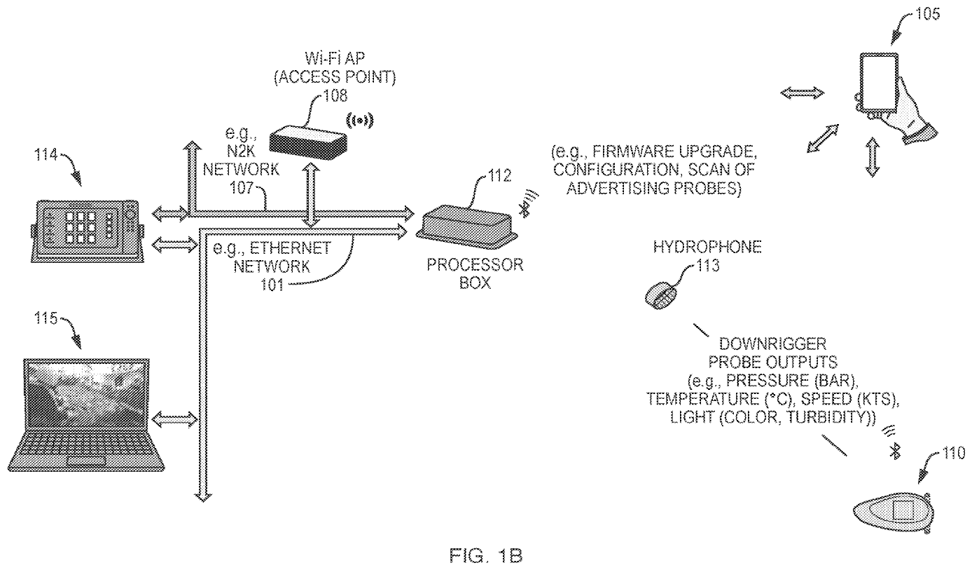

FIG. 1A-1 is a schematic diagram of an example embodiment of a system 100 for downrigger fishing. In the system 100, a fishing rod 187 on a boat 103 has a fishing line 180 attached thereto. A flasher/lure 188 is coupled to the fishing line 180 for attracting fish (not shown). A release clip 181 is used for coupling the fishing line 180 to a downrigger line 109 (lead line) of a downrigger 186. The downrigger line 109 has a lead 183 attached thereto. The system 100 comprises a downrigger probe 110 fixed on the downrigger line 109 being trolled by the boat (vessel) 103. The system 100 further comprises a processor box (not shown) configured to communicate with the downrigger probe 110 via a hydrophone 113. The downrigger probe 110 is configured to sense colors in water (not shown) around the downrigger probe 110, transform respective values of the colors sensed into an ambient color temperature of the water, and transmit the ambient color temperature acoustically through the water to the processor box via the hydrophone 113. The processor box may be configured to cause a representation of the ambient color temperature transmitted to be output to a user device, such as the user device 105 of FIG. 1B, disclosed further below for non-limiting example.

FIG. 1A-2 is a block diagram of an example embodiment of rigging within the system 100 of FIG. 1A-1.

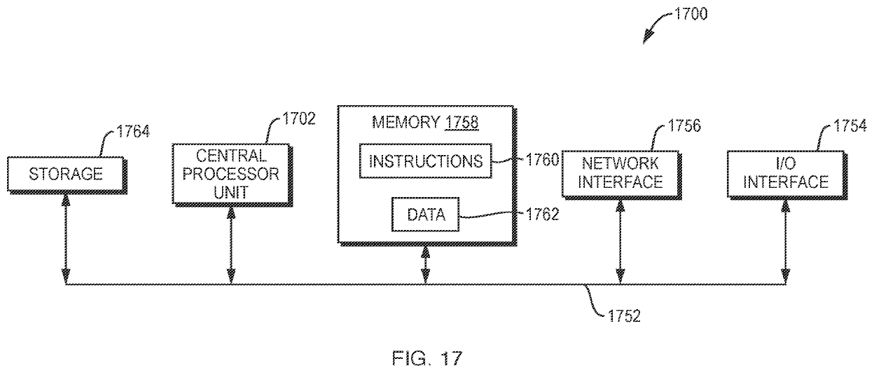

Continuing with reference to FIG. 1A-1, the downrigger probe 110 may comprise at least one processor, such as the central processing unit (CPU) 1702 of FIG. 17, disclosed further below for non-limiting example. With reference to FIG. 1A-1, the downrigger probe 110 may further comprise at least one sensor (not shown) coupled to the at least one processor. The at least one sensor may include a sensor (not shown) configured to sense colors in water (not shown) around the downrigger probe 110. The at least one processor may be configured to transform respective values of the colors sensed into an ambient color temperature (not shown) of the water around the downrigger probe 110. The downrigger probe 110 may be configured to transmit the ambient color temperature, acoustically through the water. For non-limiting example, such ambient color temperature may be transmitted to a receiver 111 of the system 100 and may be useful toward selection of a lure for the fishing.

The system 100 further includes a hydrophone cable 112, a hydrophone 113, a charger 105, and an App display 106. In the example embodiment of the system 100, the receiver 111 may be configured to receive a hydrophone signal (not shown) as input. The receiver 111 may be further configured to output data (not shown) to a user display(s), National Marine Electronics Association (NMEA) network, Ethernet network, Bluetooth® network, Wi-Fi network, or other device/network for non-limiting examples.

According to an example embodiment, the system 100 may be configured to make downrigger probe sensor measurements, transmit the downrigger probe sensor measurements via an acoustic modem (not shown), process the downrigger probe sensor measurements, and output the processed downrigger probe sensor measurements, also referred to interchangeably herein as system data, via a NMEA network (not shown) to a user device (not shown). Alternatively, such data may be output to an integrated display or via wireless communication to the user device. According to an example embodiment, the downrigger probe 110 may be configured to measure depth (e.g., via a pressure sensor), speed (e.g., via magnetic paddlewheel/hall cell), temperature, and turbidity (DSTT), as well as color temperature of the water for non-limiting examples.

The hydrophone cable 112 may be a cable that couples the hydrophone 113 to the receiver 111. The hydrophone 113 may be configured to receive acoustic messages (not shown) from the downrigger probe 110. It should be understood that the system 100 is not limited to a single downrigger probe 110 and that a single downrigger probe 110 is shown for simplicity. The hydrophone 113 may be mounted to a transom of the boat 103 for non-limiting example. Alternatively, the hydrophone 113 may be mounted thru-hull. According to a non-limiting example, that hydrophone 113 may be based on a transducer (not shown) with a compound angle to point back, while also accommodating for boat hull deadrise. The hydrophone cable 112 may be a conductive cable for non-limiting example.

The downrigger probe 110 may include sensors for turbidity, water light spectrum/intensity, or a combination thereof. Additional sensors of the downrigger probe 110 may include a depth sensor(s), speed sensor(s), and/or temperature sensor(s) for non-limiting examples. Such sensors may further include a conductive wire sensor for non-limiting example. The downrigger probe 110 may be configured to communicate acoustic messages to the hydrophone 113 and such acoustic messages may include data that is based on output from at least one sensor of the downrigger probe 110.

The downrigger probe 110 may be configured to measure depth (pressure), speed, temperature, or a combination thereof for non-limiting example. According to an example embodiment, the downrigger probe 110 may be configured to measure turbidity, water light spectrum/intensity, salinity, or a combination thereof. The downrigger probe 110 may be battery powered. The downrigger probe 110 may be configured to output measurements to an electronic display (E-display). The downrigger probe 110 may further include an electromagnetic (EM) log that measures a speed of the boat (vessel) through water, a correlation log, a Doppler sensor(s), vibration sensor(s), and/or echo sounding elements for non-limiting examples. The downrigger probe 110 may be configured to produce side scan images and/or video.

The downrigger probe 110 may include an altimeter. Such an altimeter may be used to measure and control height of the downrigger probe 110 off the bottom surface, for example, via a probe altimeter(s) configured to perform bottom tracking.

According to an example embodiment, an uplink rate employed for communicating measurements from the downrigger probe 110 may be variable. The variable uplink rate may be dependent on sensor reading. To conserve battery, the uplink rate may be adjusted, automatically, based on an operational state. For example, if the downrigger probe 110 is being deployed, there may be a fast change in pressure, and it may be useful to produce a fast upload of temperature to detect thermoclines. Once the downrigger probe 110 is fully deployed, for example, at a target depth, an upload rate may then be decreased to conserve battery.

According to an example embodiment, an indication may be generated via a sensor and output to a user device in an event a thermocline is detected. The system 100 may, in turn, be configured to use such an indication to adjust a downrigger feed, automatically, responsive to the detection represented by the indication.

According to an example embodiment, the downrigger probe 110 may include a video camera configured to record the downrigger 110 surroundings and fish at a depth. The downrigger probe 110 may be further configured to store video recordings in memory located on the downrigger probe 110. Once the downrigger probe 100 is retrieved, for example, from the water, the recordings can be uploaded to a user's device via a wireless link or a physical drive, such as a secure digital (SD) card for non-limiting example.

As disclosed above, the system may include a charger 105. The charger 105 may be configured to provide wireless charging of sensing probes, such as the downrigger probe 110, based on the Qi standard for non-limiting example. The system may further include the App display 106.

According to an example embodiment, telemetry data may be transmitted acoustically from a battery-powered sensor. The battery-powered sensor may be located in a container, such as a bottle (not shown), for non-limiting example, that may be attached to a trawl net (not shown). The trawl net may be coupled to the boat 103 by a mechanical cable and the bottle may be configured to send acoustic data to the boat 103. The acoustic data may represent measurement data obtained via the battery-powered sensor.

The system of FIG. 1A-1, disclosed above, may include an acoustic modem link from the downrigger probe 110 to the hydrophone 113 that may be located on the boat 103. Data processed and pushed from the receiver 111 may be output to a display or output via a Bluetooth connection to the App display 106. According to an example embodiment, data processed and pushed from the receiver 111 may be output to a National Marine Electronics Association (NMEA) network, Ethernet network, Bluetooth network, Wi-Fi network, or other device/network, such as disclosed with regard to FIG. 1B

FIG. 1B is a schematic diagram of an example embodiment of the system of FIG. 1A-1. With reference to FIGS. 1A and 1B, the receiver 111 may be included in a processor box 112. As such, the processor box 112 may be configured to demodulate communications received from the downrigger probe 110. The downrigger probe 110 may be upgraded, wirelessly. The downrigger probe 110 may be referred to interchangeably herein as a measurement probe, or simply as a probe. It should be understood, however, that the processor box may be configured to demodulate communications received from a plurality of measurement probes that may be similar or different measurement type probes and, thus, the processor box 112 is not limited to demodulating communications from the downrigger probe 110.

The processor box 112 may be upgraded. The processor box 112 outputs may include “Probe X” outputs (not shown). The “Probe X” outputs may include depth (m, ft), temperature (° F., ° C.), speed (kph, kts, mph), inclination (°), height (m, ft), slant range (m, ft), horizontal range (m, ft), light (intensity/color/clarity/turbidity), and/or battery charge level, lowering speed (m/min, ft/min) for non-limiting examples.

The “Probe X” outputs may include output data calculated from raw data or processed/filtered/converted data (or just the same as raw, like temperature for non-limiting example) by the processor box 112 for each Probe X. The values of such outputs may be displayed to the end user via a multi-functional display (MFD), personal computer (PC) 115, or user device 105 with an app (not shown) for non-limiting examples. For example, the probe may send its pressure (raw data), but the output of the system for the user may be the value of depth (calculated from the pressure and a user setting defining the type of water fresh/salt).

Communications between the PC 115, MFD 114, and processor box 112 may be over an Ethernet network 101 for non-limiting example. Such communications may include SDS communication for non-limiting example. Such SDS communication may be employed for firmware upgrade, monitoring, test, or configuration for non-limiting examples. SDS communication is a proprietary protocol from Airmar Technology Corporation/Marport and, thus, may not be compatible with certain external tool/equipment. As such, a specific application on the PC 115 or user device 105 (e.g., mobile/tablet device, or other user device) may be employed to provide such compatibility. At the inverse, a Webpage (HTML5 app) (not shown) may be employed that is accessible from any web browser (not shown) coupled to the Ethernet network 101, including multifunction displays (MFDs), such as the MFD 114. Such a Webpage may be employed to for monitoring and configuration, such as configuration of a number of simultaneous client connections for non-limiting example. In the system 100, a Wi-Fi access point (AP) 108 may be coupled to the Ethernet network 101 and may serve as a boat network extension. In an example embodiment, the processor box 112 and MFD 114 may be further coupled to a N2K network 107 for non-limiting example.

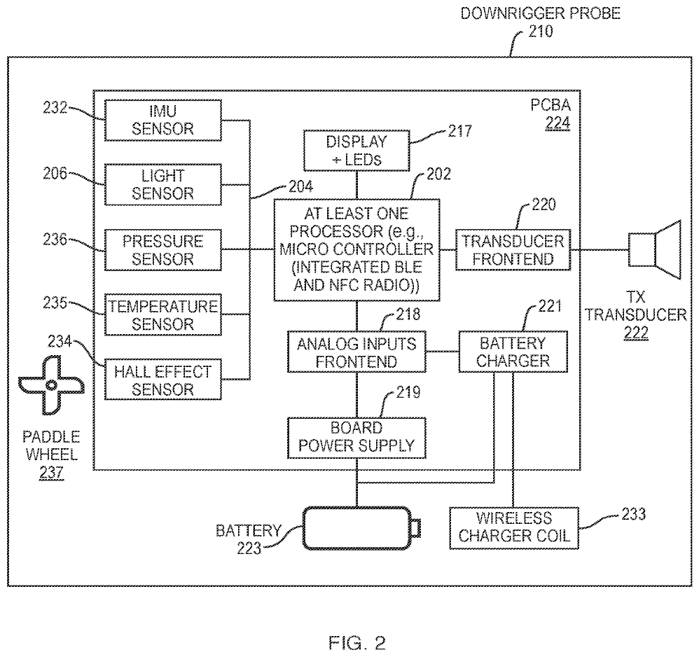

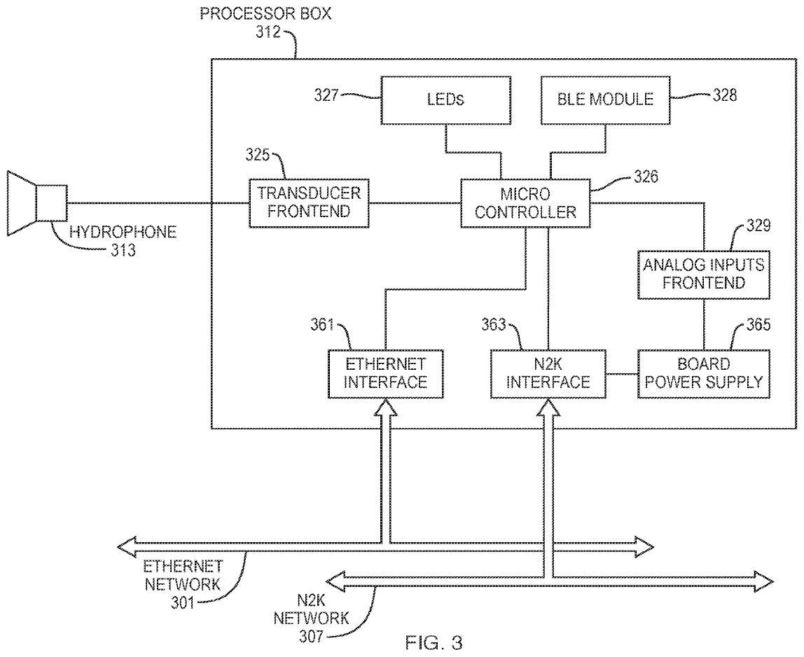

According to an example embodiment, the processor box 112 may be configured to detect that there are no hydrophone connections and may be configured to notify such condition to the user via communication to the user device 105. Such condition may be referred to as a hydrophone connection issue. According to another example embodiment, the user device 105 may be configured to communicate with a probe, such as the downrigger probe 110, directly over a Bluetooth connection. Such communication over a Bluetooth connection may include advertised data, such as a device name, probe identifier (ID), battery charge level (%), remaining operation time (h), status (e.g., in charge, outside water, etc.) or other information associated with the downrigger probe 110 for non-limiting examples. As disclosed below with regard to FIG. 2, an example embodiment may include a Bluetooth interface for the downrigger probe 110 that may be integrated with a microcontroller. For the processor box 112, such a Bluetooth interface may be integrated as disclosed further below with regard to FIG. 3.

FIG. 2 is a block diagram of an example embodiment of components of a downrigger probe 210, that may be employed as the downrigger probe 110 of FIGS. 1A and 1B, disclosed above. With reference to FIG. 2, the downrigger probe 210 may include a printed circuit board assembly (PCBA) 224 with components thereon. It should be understood that such components and an arrangement thereof is for non-limiting example. The components may include at least one processor 202, such as a microcontroller with integrated Bluetooth Low Energy (BLE) and near-field communication (NFC) radio communication capability for non-limiting example. The at least one processor 202 may be coupled to a display 217 with light emitting diodes (LEDs) (not shown) and an analog inputs frontend 218. The analog inputs frontend 218 may be coupled to a battery charger 221 and a board power supply 219 that supplies power to the PCBA 224. The board power supply 219 may be coupled to a battery 223 and the battery charger 221. The battery 223 may coupled to the battery charger 221 that may be coupled to the analog inputs frontend 218 and a wireless charging coil 233. The charging coil 233 may be configured to charge the battery 223 of the downrigger probe 210, wirelessly.

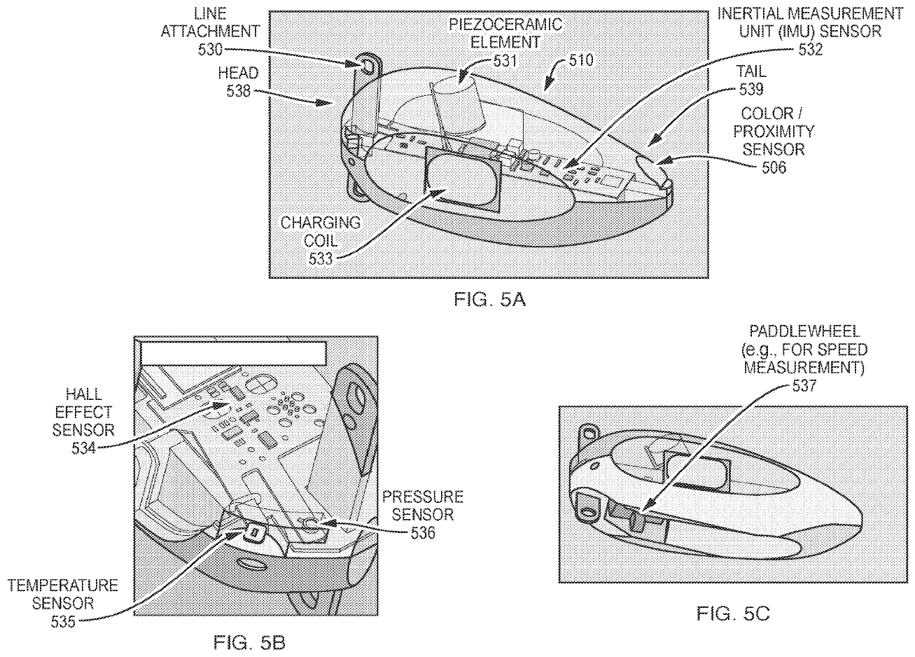

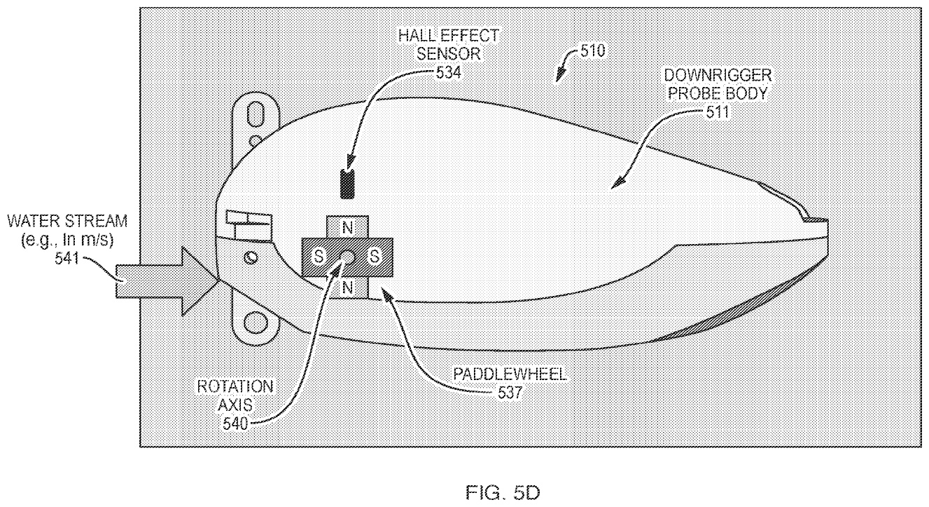

The PCBA 224 may further include the transducer frontend 220 that may include a power amplification stage (not shown) and a piezoceramic element, disclosed further below with regard to FIG. 5A. Continuing with reference to FIG. 2, the PCBA 224 may further include at least one sensor, such as an inertial measurement unit (IMU) sensor 232, a light sensor 206 (also referred to interchangeable herein as a color/proximity sensor, color-proximity sensor, or device configured to sense ambient light), pressure sensor 236, temperature sensor 235, and/or a Hall effect sensor 234 for non-limiting examples. The downrigger probe 210 may include a paddle wheel 237. The function of the paddle wheel 237 and the sensors of the PCBA 224 are disclosed further below with regard to FIGS. 5A-D.

Continuing with reference to FIG. 2, the light sensor 206 may be configured to sense colors in water (not shown) around the downrigger probe 210. The at least one processor 202 may be configured to transform respective values of the colors sensed into an ambient color temperature (not shown) of the water around the downrigger probe 210. The downrigger probe 210 may be configured to transmit the ambient color temperature, acoustically through the water, for example, via a transmit (TX) transducer 222.

The colors sensed may be RGB colors. The light sensor 206 of the downrigger probe 210 may be a device configured to sense ambient light, sense the RGB colors, and perform proximity detection for non-limiting example, such as disclosed further below with regard to FIG. 10. Continuing with reference to FIG. 2, the respective values of the colors may be RGB values of the colors sensed and the device, that is, the light sensor 206. may be coupled to the at least one processor 202 of the downrigger probe 210 via a digital bus 204. The device may be configured to transmit the RGB values to the at least one processor 202 via the digital bus 204.

To transform the respective values of the colors sensed into the ambient color temperature, the at least one processor 202 may be further configured to convert the RGB values to Commission Internationale de l′Elcairage (CIE) tristimulus values, compute normalized chromaticity values based on the CIE tristimulus values, and compute the ambient color temperature based on the normalized chromaticity values computed, such as disclosed further below with regard to FIG. 10.

Continuing with reference to FIG. 2, the downrigger probe 210 may further comprise a power amplifier stage (not shown) and a piezoceramic element (not shown) in a transducer frontend 220. The at least one processor 202 may be further configured to generate an electrical signal (not shown) representing the ambient color temperature. The power amplifier stage may be configured to amplify the electrical signal generated. The piezoceramic element may be configured to transform the electrical signal generated and amplified into an acoustic signal (not shown) that is output by the TX transducer 222. The downrigger probe 210 may be further configured to transmit the acoustic signal to transmit the ambient color temperature, acoustically, through the water.

The at least one processor 202 may be further configured to configure a configurable uplink frequency parameter for an acoustic link (not shown) based on configuration information input to the downrigger probe 210. The downrigger probe 210 may be further configured to transmit the ambient color temperature via the acoustic link based on the configurable uplink frequency parameter configured.

The light sensor 206 may be a color-and-proximity sensor configured to emit light, sense reflected light that is reflected in response to the light emitted, and output a proximity measurement based on the reflected light sensed, as disclosed further below. The proximity measurement may be affected by particles in the water and may include a near proximity measurement and a far proximity measurement, as disclosed further below. The at least one processor 202 may be further configured to determine a level of turbidity in the water based on the near proximity measurement and the far proximity measurement and to generate an electrical signal (not shown) representing the level of turbidity determined. The power amplifier stage of the transducer frontend 220 may be configured to amplify the electrical signal generated. The piezoceramic element may be configured to transform the electrical signal generated and amplified into an acoustic signal. The downrigger probe 210 may be further configured to transmit the acoustic signal to transmit, acoustically through the water, the level of turbidity determined.

According to an example embodiment, the Hall effect sensor 234 may be configured to sense magnetic field changes generated by rotation of the magnetic paddlewheel 237 and to output a Hall effect sensor signal (not shown) based on the magnetic field changes sensed. The least one processor 202 may be further configured to determine a speed of the water around the downrigger probe 210 based on the Hall effect sensor signal output and to transmit, acoustically through the water, the speed determined.

A frequency of the Hall effect sensor signal output may be based on a rotation speed of the magnetic paddlewheel 237. The rotation speed may be affected by the speed of the water. The at least one processor 202 may be further configured to determine the frequency of the Hall effect sensor signal output and to determine the speed of the water based on the frequency determined and a conversion coefficient for the downrigger probe 210, as disclosed further below.

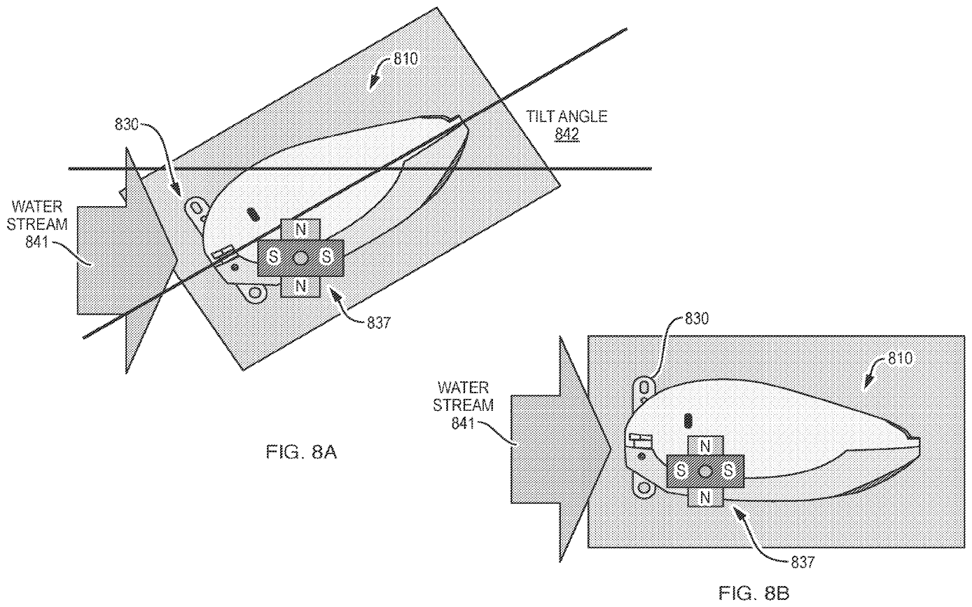

The downrigger probe 210 may further comprise at least one memory (not shown) coupled to the at least one processor 202 and the IMU sensor 232. The at least one memory may include a lookup table (not shown). The IMU sensor 232 may be configured to measure a tilt angle of the downrigger probe 210, such as disclosed further below with regard to FIGS. 8A-B. Continuing with reference to FIG. 2, the at least one processor 202 may be further configured to select the conversion coefficient from the lookup table based on the tilt angle measured and to determine the speed of the water based on the frequency determined and the conversion coefficient selected. The at least one processor 202 may be further configured to generate an electrical signal (not shown) based on the speed determined. The power amplifier stage of the transducer frontend 220 may be configured to amplify the electrical signal generated. The piezoceramic element may be configured to transform the electrical signal generated and amplified into an acoustic signal. The downrigger probe 210 may be further configured to transmit the acoustic signal to transmit, acoustically through the water, the speed determined.

The temperature sensor 235 may be configured to sense water temperature of the water around the downrigger probe 210. The downrigger probe 210 may be further configured to transmit, acoustically through the water, the water temperature sensed, via the TX transducer 222. With reference to FIGS. 1A-B and 2, the transducer frontend 220 may be coupled to the TX transducer 222 of the downrigger probe (110, 210) and such transducer may be employed to transmit messages, such as a message representing the temperature sent acoustically to the processor box 112 via the hydrophone 113 coupled to the processor box 112, as disclosed below with regard to FIG. 3.

FIG. 3 is a block diagram of an example embodiment of components of a processor box 312. The processor box 312 may be employed as the processor box 112 of FIGS. 1A-B, disclosed above. With reference to FIG. 3, the processor box 312 may be coupled to a hydrophone 313 to receive messages from measurement probes, such as the downrigger probe 110 and downrigger probe 210 of FIGS. 1A-B and 2, respectively.

Continuing with reference to FIG. 3, the processor box 312 may include a microcontroller (processor) 326 that may be coupled to a transducer frontend 325 to receive messages via the hydrophone 313. The transducer frontend 325 may be configured to convert acoustic messages into electrical messages that can be decoded by the microcontroller 326. The microcontroller 326 may be further coupled to LEDs 327, a BLE module 328, an Ethernet interface 361, and a N2K interface 363. The Ethernet interface 361 and N2K interface 363 may be coupled to an Ethernet network 301 and N2K network 307, respectively.

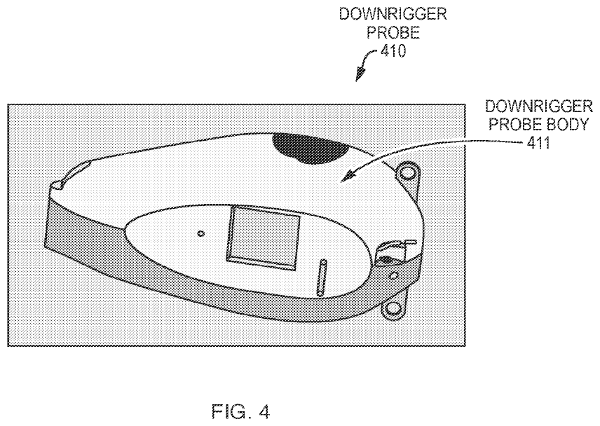

The Ethernet network 301 and N2K network 307 may be the Ethernet network 101 and N2K network 107 of FIG. 1B, respectively. With reference to FIG. 3, the N2K interface 363 may be coupled to a board power supply 365 of the processor box 312. The processor box 312 may further include an analog inputs frontend 329 interposed between the board power supply 365 and the microcontroller 326 of the processor box 312. The processor box 312 may receive acoustic messages via the hydrophone 313, as disclosed above, and such messages may be sourced by a downrigger probe, such as the downrigger probe 410 of FIG. 4, disclosed below.

FIG. 4 is an image of an example embodiment of an overall shape of a downrigger probe body 411 of a downrigger probe 410 for non-limiting example. The downrigger probe 410 may be employed as the downrigger probe 110 and 210 of FIGS. 1A-B and FIG. 2, respectively, and may include a plurality of elements, such as disclosed above with regard to FIG. 2, and below with regard to FIGS. 5A-D.

FIGS. 5A-D are views of example embodiments of elements of the downrigger probe 510, that may be employed as the downrigger probe 110, 210, or 410 of FIGS. 1A-B, 2, and 4, respectively, for non-limiting example. With reference to FIGS. 5A-C, elements of the downrigger probe 510 may include at least one processor (not shown), a line attachment 530, a piezoceramic element 531, an IMU sensor 532, a color/proximity sensor 506, a charging coil 533, a Hall effect sensor 534, a temperature sensor 535, a pressure sensor 536, and a magnetic paddlewheel 537 for non-limiting examples. The line attachment 530 may be located at a head 538 of the downrigger probe 510 and the color/proximity sensor 506 may be located at a tail 539 of the downrigger probe 510.

The line attachment 530 may be a metal bridle, for non-limiting example, that may be used to attach the downrigger probe 510 to a downrigger line (not shown). The piezoceramic element 531 may be used to transmit acoustic signals over water. The color/proximity sensor 506 may be used to sense color and luminosity in water, as well as to provide a proximity measurement. The paddlewheel 537 may be used for speed measurement. According to an example embodiment, the paddlewheel 537 may be configured to have magnets loaded on each of its blades. A rotation speed of the paddlewheel 537 may depend on a speed of the water around the downrigger probe 510. The Hall effect sensor 534 may sense magnetic field changes near the paddlewheel 537 and, thus, may be used to sense magnetic field changes generated by rotation of the paddlewheel 537.

The IMU sensor 532 may be used to sense inertial motion of the downrigger probe 510. The charging coil 533 may be used to charge a battery (not shown) of the downrigger probe 510, wirelessly. The pressure sensor 536 may be used to sense hydrostatic pressure (not shown) around the downrigger probe 510. As the downrigger probe 510 is moving forward through water, the paddlewheel 537 may be exposed to water flow, such as disclosed below with regard to FIG. 5D.

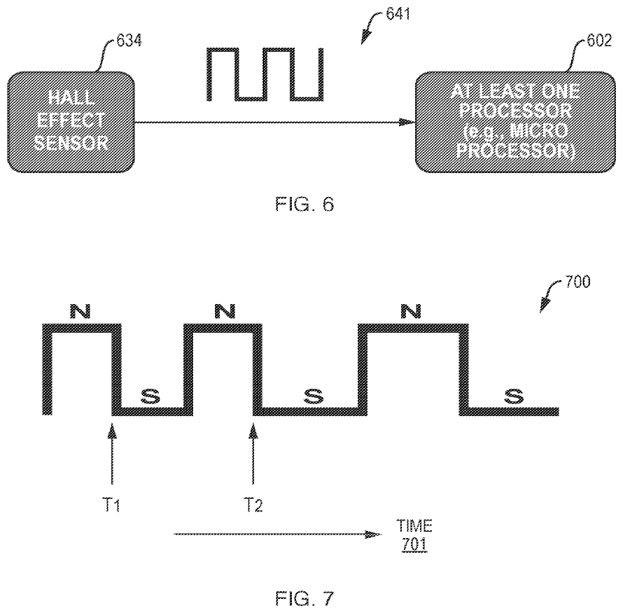

With reference to FIG. 5D, the paddlewheel 537 is coupled to the downrigger probe body 511 and the paddlewheel 537 has a rotation axis 540. As the paddlewheel 537 is exposed to a water stream 541, the paddlewheel 537 enters into rotation. The Hall effect sensor 534 senses magnetic fields change (e.g., N-S-N . . . ), and a frequency of such transition depends on a speed of the water stream 541, that is, the water speed. A signal output from the Hall effect sensor 534 may be a square wave for non-limiting example, such as disclosed below with regard to FIG. 6.

FIG. 6 is a block diagram of an example embodiment of a signal 641 output from a Hall effect sensor 634. The signal 641 output from the Hall effect sensor 634 may be a square type signal, such as a square wave, and its frequency may depend on a paddlewheel rotation speed, as disclosed above. With reference to FIG. 5D and FIG. 6, at least one processor 602 (e.g., a microprocessor) of the downrigger probe 510 may acquire the signal 641 and measure time between transitions of such signal, as disclosed below with regard to FIG. 7.

FIG. 7 is a timing diagram 700 of an example embodiment of the signal 641 of FIG. 6 over time 701. With reference to FIG. 6 and FIG. 7, the at least one processor 602 may measure time between transitions T2 and T1 of the signal 641 output from the Hall effect sensor 634. The speed of the water may be computed by the at least one processor 602 using the following equation:

$$S = K / ( T 2 - T 1 ) ,$$

where S is the speed of water, T2 and T1 are measured by the at least one processor 602, and K is a conversion coefficient. The conversion coefficient K may be measured in a flume tank for non-limiting example, and may depend on a probe hydrodynamic in water. Such determination of the speed of water does not, however, take into account a tilt of the downrigger probe. Such tilt is disclosed below with regard to FIGS. 8A and 8B.

FIGS. 8A and 8B are views of an example embodiment of a tilt effect of a downrigger probe 810 due to a water stream 841. With a drag of a downrigger line (not shown) attached to the line attachment 830, the downrigger probe 810 may proceed in water with a tilt angle 842. This tilt angle 842 modifies the exposure of the paddlewheel 837 to the water stream 841. The K coefficient is then affected by the tilt angle 842. The tilt angle 842 may be measured by an IMU sensor of the downrigger probe, such as the IMU sensor 532, disclosed above, and may be zero, such as shown in FIG. 8B.

Continuing with reference to FIGS. 8A and 8B, the K coefficient may be different for every tilt angle 842. A correspond K value for each tilt angle 842 may be measured in a flume tank for non-liming example. With reference to FIGS. 5-7, 8A, and 8B, the at least one processor 602 may employ a lookup table (not shown) to store such corresponding K values per tilt angle 842 and select K based on a current tilt angle value of the tilt angle 842 of the downrigger probe 810, as measured by the IMU sensor 532. The speed of water may be computed in accordance with the following equation:

$$S = K ( at tilt angle ) / ( T 2 - T 1 ) ,$$

where: S is the speed of water, T2 and T1 are measured by the at least one processor 602, K is a conversion coefficient that depends on the tilt angle 842 and a corresponding value for same as measured using a downrigger probe in a flume tank, as disclosed above.

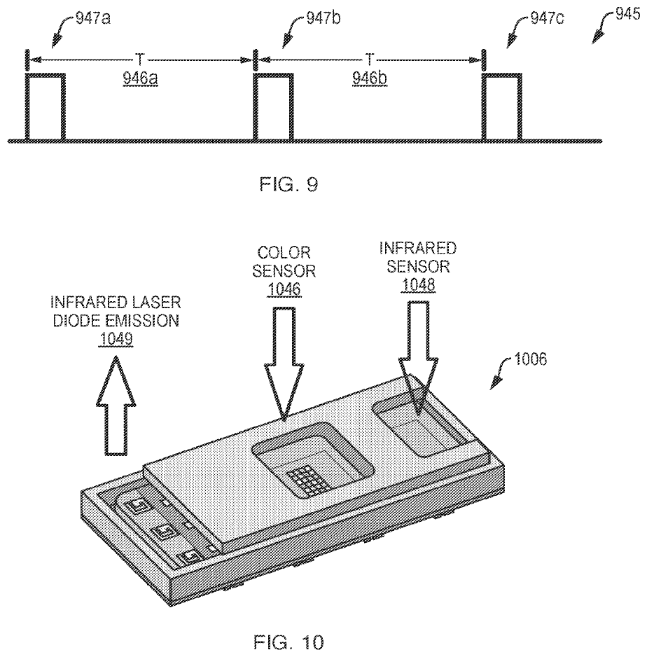

Once the S value is known, the at least one processor 602 may, for non-limiting example, generate an electrical signal that includes electric pulses with an interval modulated based on the S value. This modulation type is known as Pulse Position Modulation. An example embodiment of such an electrical signal is disclosed below with regard to FIG. 9.

FIG. 9. is a timing diagram of an example embodiment of an electrical signal 945 that may represent water speed. With reference to FIG. 6 and FIG. 9, time (946a, 946b) between electric pulses (947a, 947b, 947c) may be computed by the at least one processor 602 according to the following equation:

$$T = L * S ,$$

where T is the time in seconds, L is a speed to time conversion factor (e.g, defined with respect to a speed target range), and S is the value of the water speed disclosed above. With reference to FIG. 5A and FIG. 9, after a power amplifier stage (not shown) of the downrigger 510 amplifies the electrical signal 945, such amplified signal (not shown) may be applied to the piezoceramic element 531 that is configured to perform electric-to-acoustic signal conversion. The speed value S may then be transmitted through water via a hydrophone, such that it may be received and decoded by a receiver on a boat, following the opposite signal processing.

FIG. 10 is a schematic diagram of an example embodiment of a device 1006 of a downrigger probe, such as the downrigger probe 110, 210, 410, and 510 of FIGS. 1A-B, 2, 4, and 5A, respectively, disclosed above. Continuing with reference to FIG. 5A and FIG. 10 the device 1006 may be located at the tail 539 of the downrigger probe 510. The device 1006 may include a color sensor 1046 and infrared sensor 1048. The device 1006 may provide infrared laser diode emission 1049 and the infrared sensor 1048 may sense a reflection of such emission, for example, from particles in water. The device 1006 may feature light and color (RGB) sensing, and proximity detection. The device 1006 may be a TMD3719 device for non-limiting example.

The device 1006 may be coupled to at least one processor of the downrigger probe 510 via a digital bus (not shown). The device 1006 may sense colors (red, green, blue, light intensity) and then store measurements of same into memory buffers (not shown) of the downrigger probe 510 that the at least one processor is able to read.

Color temperature is a parameter that describes the color of a visible light source by comparing it to the color of light emitted by an idealized opaque, non-reflective body. From the red (R), green (G), blue (B), and illuminance measurements of the device 1006, the at least one processor may determine an ambient color temperature of water around the downrigger probe 510.

The at least one processor may convert the RGB values to CIE tristimulus values (XYZ) as follows:

$$X = ( - 0.14282 ) ( R ) + ( 1.54924 ) ( G ) + ( - 0.95641 ) ( B ) ,$$

$$Y = ( - 0.32466 ) ( R ) + ( 1.57837 ) ( G ) + ( - 0.73191 ) ( B ) = Illumminance ,$$

$$Z = ( - 0.68202 ) ( R ) + ( 0.77073 ) ( G ) + ( 0.56332 ) ( B ) .$$

The at least one processor of the downrigger probe 510 may compute normalized chromaticity values as follows:

$$x = X / ( X + Y + Z ) ,$$

$$y = Y / ( X + Y + Z ) .$$

The at least one processor of the downrigger probe 510 may then compute the correlated color temperature (CCT) value as:

$$C C T = 449 n 3 + 3 \; 525 n 2 + 682 3.3 n + 5520.33 ,$$

where n=(x−0.3320)/(0.1858−y).

The CCT value may be expressed in Kelvin. Once the CCT value is known, the at least one processor may generate electric pulses with an interval modulated based on the CCT value. This modulation type is known as Pulse Position Modulation, as disclosed above. Time between pulses may calculated by the at least one processor using the following equation:

$$T = L * C C T ,$$

where T is the time in seconds, L is a color temperature to time conversion factor, and CCT is the value of the color temperature.

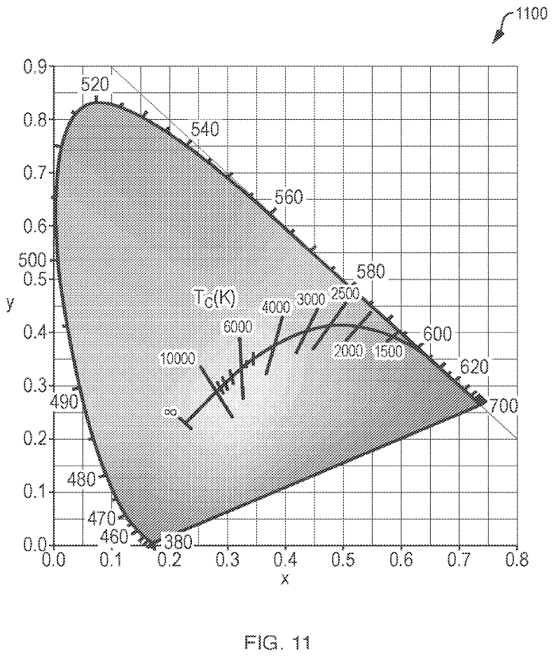

Similar to the speed signal disclosed above, after a power amplifier stage, an electrical signal representing the color temperature, that is, the CCT, may be applied to the piezoceramic element 531 that performs electric-to-acoustic signal conversion. The color temperature value may then be transmitted by the downrigger probe through water, and decoded by the receiver on the boat, following the opposite signal processing. The CCT value may be viewed on a display of a user device, for not limiting example, as a cursor placed on a color gradient, such as the color gradient of FIG. 11, disclosed below.

FIG. 11 is a graph of an example embodiment of a color gradient 1100. The color gradient 1100 may be used to display a color temperature of water that may be determined by an example embodiment of a downrigger probe disclosed herein.

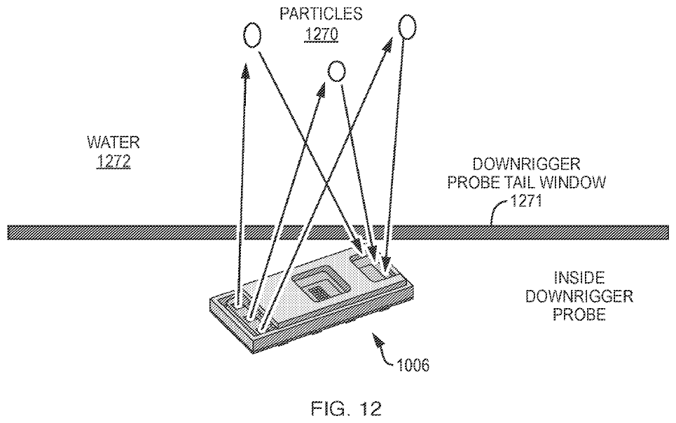

With reference back to FIG. 5A and FIG. 10, the device 1006 may also be a proximity sensor. Such a proximity sensor may be employed to detect particles in the water around the downrigger probe 510, such as disclosed below with regard to FIG. 12.

FIG. 12 is a schematic diagram of an example embodiment of the device 1006 of FIG. 10, detecting particles 1270. With reference to FIGS. 5A, 10, and 12, the device 1006 is deployed inside the downrigger probe 510 and beneath a window 1271 that the tail 539 of the downrigger probe 510. Such window may be referred to interchangeably herein as a downrigger probe tail window 1271. According to an example embodiment, detection of the particles 1270 in the water 1272 may be employed to determine a level of turbidity of the water.

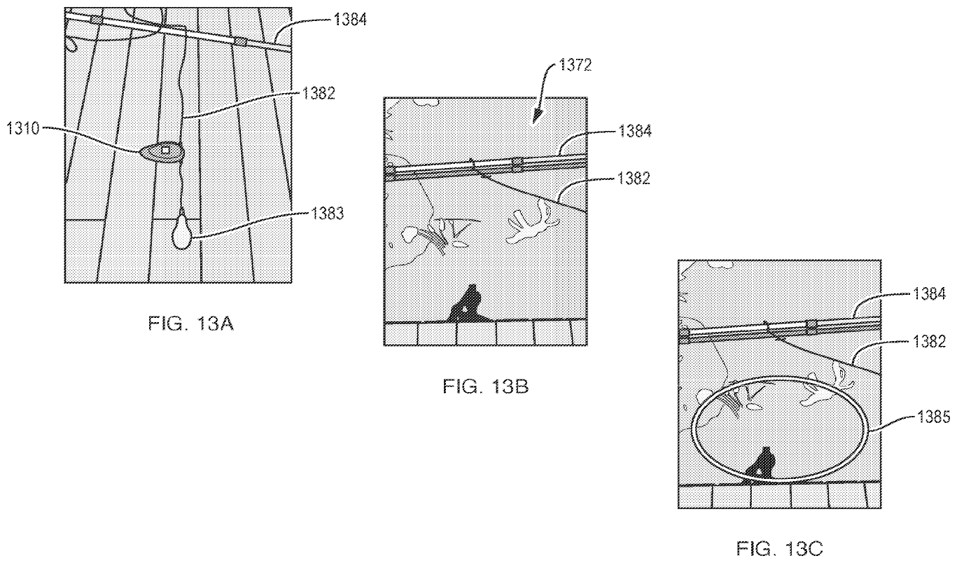

For example, the device 1006 may have a reflected light sensor, an analog-to-digital converter, and may be coupled to the at least one processor of the downrigger probe 510 via a digital bus (not shown). The device 1006 may include a storage buffer for proximity measurement. Such proximity measurement may include a far proximity measurement and a near proximity measurement. The at least one processor may read those two values and employ same to determine a level of turbidity of the water 1272. Once this turbidity level is determined by the at least one processor, the same manner of conversion to acoustic signal may be used as disclosed above with regard to speed or color temperature measurements. A trial for such turbidity level measure was performed in a pond for non-limiting example as disclosed below with regard to FIGS. 13A-C.

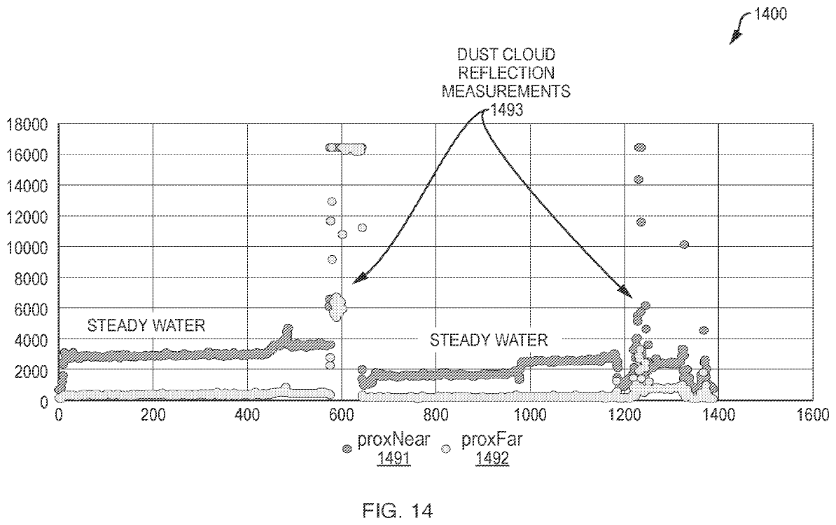

FIGS. 13A-C are images of an example embodiment of a trial for turbidity measurement. In FIG. 13A, a line 1382 with a weight 1383 and a downrigger probe 1310 are illustrated as being attached to a pole 1384. In FIG. 13B, the line 1382 is dipped into the water 1372 and there is mud (not shown) at the pond floor. After a few minutes, the pond floor is disturbed to generate a dust cloud 1385 illustrated in FIG. 13C. A reflection of the dust cloud 1385 was measured, as disclosed below with regard to FIG. 14.

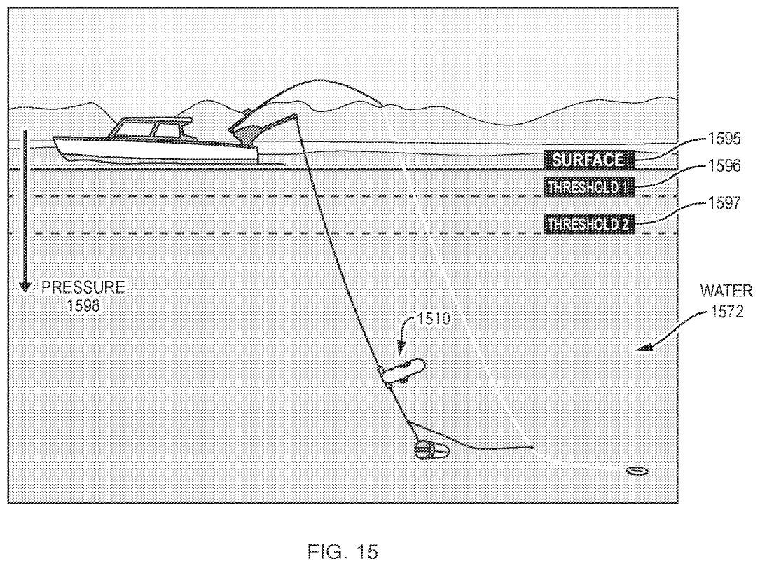

FIG. 14 is a graph 1400 of an example embodiment of proximity measurement raw data 1490 that includes near proximity measurements 1491 and far proximity measurements 1492 for particles of the dust cloud 1385 of FIG. 13C. With reference to FIGS. 5A, 10, 13A-C, and 14, such dust cloud reflection measurements 1493 are from proximity measurement raw data produced by the device 1006 in the downrigger probe 510. As disclosed above, the downrigger probe 510 may include a pressure sensor 536 that may be employed to sense pressure applied to the downrigger probe 510, as disclosed below with regard to FIG. 15.

FIG. 15 is an image of an example embodiment of pressure thresholds, namely a first threshold 1596 and a second threshold 1597. In the example embodiment, a downrigger probe 1510 is deployed below a surface 1595 of the water 1572. The downrigger probe may include a pressure sensor (no shown) and at least one processor (not shown). The at least one processor may be configured to change an operating state of the downrigger probe 1510 based on pressure 1598 sensed by the pressure sensor. In an event the pressure sensed is below the first threshold 1596, the at least one processor may be configured to cause the downrigger probe 1510 to stop transmitting data, acoustically, and to enter a standby state that limits processing to reduce power consumption. In an event the pressure 1598 sensed is greater than a second threshold 1597, the at least one processor may be further configured to cause the downrigger probe 1510 to change the operating state from the standby state to an active state in which acoustic transmission is enabled and processing is not limited. Such operating state based on pressure sensing avoids use of electrodes to determine when the downrigger probe 1510 is above or below the surface 1595 of the water 1572. Such electrodes may degrade over time due to corrosion and employing pressure sensing instead of the electrodes avoids faults due to such corrosion and cost for replacement of the electrodes due to same.

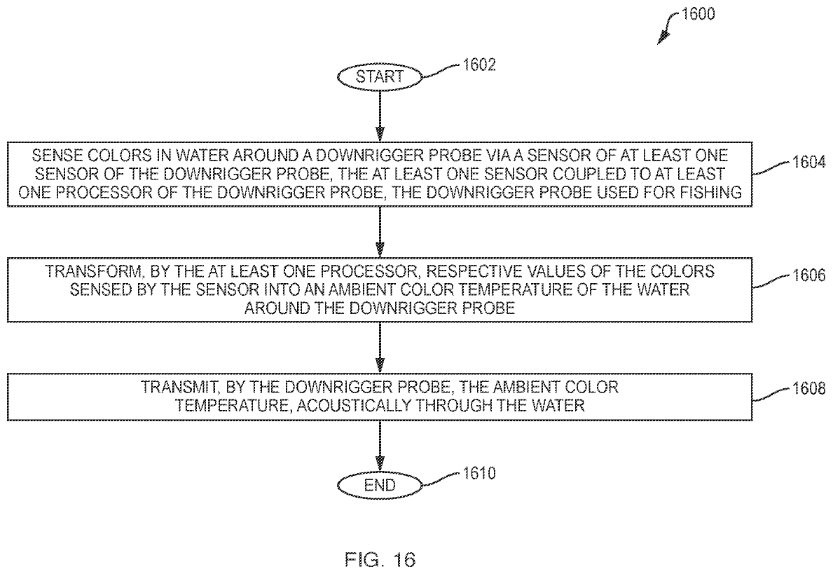

FIG. 16 is a flow diagram 1600 of an example embodiment of a method. The method begins (1602) and comprises sensing colors in water around a downrigger probe via a sensor of at least one sensor of the downrigger probe, the at least one sensor is coupled to at least one processor of the downrigger probe, the downrigger probe is used for fishing (1604). The method further comprises transforming, by the at least one processor, respective values of the colors sensed by the sensor into an ambient color temperature of the water around the downrigger probe (1606) and transmitting, by the downrigger probe, the ambient color temperature acoustically through the water (1608). The method thereafter ends (1610) in the example embodiment.

The colors sensed may be RGB colors. The respective values of the colors may be RGB values of the colors sensed. The sensor may be a device coupled to the at least one processor of the downrigger probe via a digital bus. The method may further comprise, by the device of the downrigger probe, sensing ambient light, sensing the RGB colors, performing proximity detection, generating the RGB values based on the RGB colors sensed, and transmitting the RGB values to the at least one processor via the digital bus.

The method may further comprise attaching the downrigger probe to a downrigger line via a line attachment of the downrigger probe. The line attachment may be a metal bridle for non-limiting example.

The respective values of the colors may be RGB values. Transforming the respective values of the colors sensed into the ambient color temperature may include converting the RGB values to Commission Internationale de l′Elcairage (CIE) tristimulus values, computing normalized chromaticity values based on the CIE tristimulus values, and computing the ambient color temperature based on the normalized chromaticity values computed. The ambient color temperature computed is expressed in Kelvin.

The method may further comprise, by the at least one processor, generating an electrical signal representing the ambient color temperature. The method may further comprise, by a power amplifier stage of the downrigger probe, amplifying the electrical signal generated. The method may further comprise, by a piezoceramic element of the downrigger probe, transforming the electrical signal generated and amplified into an acoustic signal. The method may further comprise, by the downrigger probe, transmitting the acoustic signal to transmit the ambient color temperature, acoustically, through the water.

The sensor may be a color-and-proximity sensor. The method may further comprise, by the color-and-proximity sensor, emitting light, sensing reflected light that is reflected in response to the light emitted, and outputting a proximity measurement based on the reflected light sensed. The proximity measurement may be affected by particles in the water and may include a near proximity measurement and a far proximity measurement. The method may further comprise, by the at least one processor, determining a level of turbidity in the water based on the near proximity measurement and the far proximity measurement and generating an electrical signal representing the level of turbidity determined. The method may further comprise, by a power amplifier stage of the downrigger probe, amplifying the electrical signal generated. The method may further comprise, by a piezoceramic element of the downrigger probe, transforming the electrical signal generated and amplified into an acoustic signal. The method may further comprise, by the downrigger probe, transmitting the acoustic signal to transmit, acoustically through the water, the level of turbidity determined.

The at least one sensor may further include a Hall effect sensor. The method may further comprise, by the Hall effect sensor, sensing magnetic field changes generated by rotation of a magnetic paddlewheel of the downrigger probe and outputting a Hall effect sensor signal based on the magnetic field changes sensed. The method may further comprise, by the at least one processor, determining a speed of the water around the downrigger probe based on the Hall effect sensor signal output and transmitting, acoustically through the water, the speed determined.

A frequency of the Hall effect sensor signal output may be based on a rotation speed of the magnetic paddlewheel. The rotation speed may be affected by the speed of the water. The method may further comprise, by the at least one processor, determining the frequency of the Hall effect sensor signal output. Determining the speed of the water may be based on the frequency determined and a conversion coefficient for the downrigger probe.

At least one memory may be coupled to the at least one processor. The at least one memory may include a lookup table. The method may further comprise, by an inertial measurement unit (IMU) sensor of the downrigger probe, measuring a tilt angle of the downrigger probe. The method may further comprise, by the at least one processor, selecting the conversion coefficient from the lookup table based on the tilt angle measured. The method may further comprise, by the at least on processor, determining the speed of the water based on the frequency determined and the conversion coefficient selected.

The method may further comprise, by the at least one processor, generating an electrical signal based on the speed determined. The method may further comprise, by a power amplifier of the downrigger probe, amplifying the electrical signal generated. The method may further comprise, by a piezoceramic element of the downrigger probe, transforming the electrical signal generated and amplified into an acoustic signal. The method may further comprise, by the downrigger probe, transmitting the acoustic signal to transmit, acoustically through the water, the speed determined.

The least one sensor may further include a pressure sensor. The method may further comprise, by the pressure sensor, sensing pressure applied to the downrigger probe. The method may further comprise, by the at least one processor, changing an operating state of the downrigger probe based on the pressure sensed.

The method may further comprise, by the at least one processor, causing the downrigger probe to stop transmitting data, acoustically, and to enter a standby state that limits processing to reduce power consumption in an event the pressure sensed is below a first threshold. The method may further comprise causing the downrigger probe to change the operating state from the standby state to an active state in which acoustic transmission is enabled and processing is not limited in an event the pressure sensed is greater than a second threshold.

The method may further comprise, by the at least one processor, configuring a configurable uplink frequency parameter for an acoustic link based on configuration information input to the downrigger probe. The method may further comprise, by the downrigger probe, transmitting the ambient color temperature via the acoustic link based on the configurable uplink frequency parameter configured.

The at least one sensor may further include a temperature sensor. The method may further comprise, by the temperature sensor, sensing water temperature of the water around the downrigger probe. The method may further comprise, by the downrigger probe, transmitting acoustically through the water, the water temperature sensed.

The method may further comprise charging a battery of the downrigger probe, wirelessly, via a charging coil of the downrigger probe.

FIG. 17 is a block diagram of an example of the internal structure of a computer 1700 in which various embodiments of the present disclosure may be implemented. The computer 1700 contains a system bus 1752, where a bus is a set of hardware lines used for data transfer among the components of a computer or digital processing system. The system bus 1752 is essentially a shared conduit that connects different elements of a computer system (e.g., processor, disk storage, memory, input/output ports, network ports, etc.) that enables the transfer of information between the elements. Coupled to the system bus 1752 is an I/O device interface 1754 for connecting various input and output devices (e.g., keyboard, mouse, displays, printers, speakers, etc.) to the computer 1700. A network interface 1756 allows the computer 1700 to connect to various other devices attached to a network (e.g., global computer network, wide area network, local area network, etc.). Memory 1758 provides volatile or non-volatile storage for computer software instructions 1760 and data 1762 that may be used to implement embodiments of the present disclosure, where the volatile and non-volatile memories are examples of non-transitory media. Disk storage 1764 provides non-volatile storage for computer software instructions 1760 and data 1762 that may be used to implement embodiments of the present disclosure. A central processor unit 1702 is also coupled to the system bus 1752 and provides for the execution of computer instructions.

As used herein, the term “engine” or “module” may refer to any hardware, software, firmware, electronic control component, processing logic, and/or processor device, individually or in any combination, including without limitation: an application specific integrated circuit (ASIC), a field-programmable gate-array (FPGA), an electronic circuit, a processor and memory that executes one or more software or firmware programs, and/or other suitable components that provide the described functionality.

Example embodiments disclosed herein may be configured using a computer program product; for example, controls may be programmed in software for implementing example embodiments. Further example embodiments may include a non-transitory computer-readable medium containing instructions that may be executed by a processor, and, when loaded and executed, cause the processor to complete methods described herein. It should be understood that elements of the block and flow diagrams may be implemented in software or hardware, such as via one or more arrangements of circuitry of FIG. 17, disclosed above, or equivalents thereof, firmware, a combination thereof, or other similar implementation determined in the future.

In addition, the elements of the block and flow diagrams described herein may be combined or divided in any manner in software, hardware, or firmware. If implemented in software, the software may be written in any language that can support the example embodiments disclosed herein. The software may be stored in any form of computer readable medium, such as random access memory (RAM), read only memory (ROM), compact disk read-only memory (CD-ROM), and so forth. In operation, a general purpose or application-specific processor or processing core loads and executes software in a manner well understood in the art. It should be understood further that the block and flow diagrams may include more or fewer elements, be arranged or oriented differently, or be represented differently. It should be understood that implementation may dictate the block, flow, and/or network diagrams and the number of block and flow diagrams illustrating the execution of embodiments disclosed herein.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A downrigger probe for fishing, the downrigger probe comprising:
at least one processor; and
at least one sensor coupled to the at least one processor, the at least one sensor including a sensor configured to sense colors in water around the downrigger probe, the at least one processor configured to transform respective values of the colors sensed into an ambient color temperature of the water around the downrigger probe, the downrigger probe configured to transmit the ambient color temperature.

2. The downrigger probe of claim 1, wherein:
the colors sensed are RGB colors;
the sensor of the downrigger probe is a device configured to sense ambient light, sense the RGB colors, and perform proximity detection;
the respective values of the colors are RGB values of the colors sensed;
the device is coupled to the at least one processor of the downrigger probe via a digital bus; and
the device is configured to transmit the RGB values to the at least one processor via the digital bus.

3. The downrigger probe of claim 1, wherein the downrigger probe has a tail and wherein the sensor is located at the tail.

4. The downrigger probe of claim 1, wherein the downrigger probe further comprises a line attachment configured to attach the downrigger probe to a downrigger line and wherein the line attachment is a metal bridle.

5. The downrigger probe of claim 1, wherein the respective values of the colors are RGB values and wherein, to transform the respective values of the colors sensed into the ambient color temperature, the at least one processor is further configured to:
convert the RGB values to Commission Internationale de l′Elcairage (CIE) tristimulus values;
compute normalized chromaticity values based on the CIE tristimulus values; and
compute the ambient color temperature based on the normalized chromaticity values computed, wherein the ambient color temperature computed is expressed in Kelvin.

6. The downrigger probe of claim 1, wherein the downrigger probe further comprises a power amplifier stage and a piezoceramic element and wherein:
the at least one processor is further configured to generate an electrical signal representing the ambient color temperature;
the power amplifier stage is configured to amplify the electrical signal generated;
the piezoceramic element is configured to transform the electrical signal generated and amplified into an acoustic signal; and
the downrigger probe is further configured to transmit the acoustic signal to transmit the ambient color temperature, acoustically, through the water.

7. The downrigger probe of claim 1, wherein the downrigger probe further comprises a power amplifier stage and a piezoceramic element and wherein:
the sensor is a color-and-proximity sensor configured to emit light, sense reflected light that is reflected in response to the light emitted, and output a proximity measurement based on the reflected light sensed;
the proximity measurement is affected by particles in the water and includes a near proximity measurement and a far proximity measurement;
the at least one processor is further configured to determine a level of turbidity in the water based on the near proximity measurement and the far proximity measurement and to generate an electrical signal representing the level of turbidity determined;
the power amplifier stage is configured to amplify the electrical signal generated;
the piezoceramic element is configured to transform the electrical signal generated and amplified into an acoustic signal; and
the downrigger probe is further configured to transmit the acoustic signal to transmit, acoustically through the water, the level of turbidity determined.

8. The downrigger probe of claim 1, further comprising a magnetic paddlewheel and wherein:
the at least one sensor further includes a Hall effect sensor configured to sense magnetic field changes generated by rotation of the magnetic paddlewheel and to output a Hall effect sensor signal based on the magnetic field changes sensed; and
the at least one processor is further configured to determine a speed of the water around the downrigger probe based on the Hall effect sensor signal output and to transmit, acoustically through the water, the speed determined.

9. The downrigger probe of claim 8, wherein:
a frequency of the Hall effect sensor signal output is based on a rotation speed of the magnetic paddlewheel;
the rotation speed is affected by the speed of the water; and
the at least one processor is further configured to determine the frequency of the Hall effect sensor signal output and to determine the speed of the water based on the frequency determined and a conversion coefficient for the downrigger probe.

10. The downrigger probe of claim 9, further comprising at least one memory coupled to the at least one processor and an inertial measurement unit (IMU) sensor and wherein:
the at least one memory includes a lookup table;
the IMU sensor is configured to measure a tilt angle of the downrigger probe; and
the at least one processor is further configured to select the conversion coefficient from the lookup table based on the tilt angle measured and to determine the speed of the water based on the frequency determined and the conversion coefficient selected.

11. The downrigger probe of claim 8, wherein the downrigger probe further comprises a power amplifier stage and a piezoceramic element and wherein:
the at least one processor is further configured to generate an electrical signal based on the speed determined;
the power amplifier stage is configured to amplify the electrical signal generated;
the piezoceramic element is configured to transform the electrical signal generated and amplified into an acoustic signal; and
the downrigger probe is further configured to transmit the acoustic signal to transmit, acoustically through the water, the speed determined.

12. The downrigger probe of claim 1, wherein the at least one sensor further includes a pressure sensor configured to sense pressure applied to the downrigger probe and wherein the at least one processor is further configured to change an operating state of the downrigger probe based on the pressure sensed.

13. The downrigger probe of claim 12, wherein:
in an event the pressure sensed is below a first threshold, the at least one processor is further configured to cause the downrigger probe to stop transmitting data, acoustically, and to enter a standby state that limits processing to reduce power consumption; and
in an event the pressure sensed is greater than a second threshold, the at least one processor is further configured to cause the downrigger probe to change the operating state from the standby state to an active state in which acoustic transmission is enabled and processing is not limited.

14. The downrigger probe of claim 1, wherein:
the at least one processor is further configured to configure a configurable uplink frequency parameter for an acoustic link based on configuration information input to the downrigger probe and
the downrigger probe is further configured to transmit the ambient color temperature via the acoustic link based on the configurable uplink frequency parameter configured.

15. The downrigger probe of claim 1, wherein the at least one sensor further includes a temperature sensor configured to sense water temperature of the water around the downrigger probe and wherein the downrigger probe is further configured to transmit, acoustically through the water, the water temperature sensed.

16. The downrigger probe of claim 1, further comprising a charging coil and a battery and wherein the charging coil is configured to charge the battery of the downrigger probe, wirelessly.

17. A method comprising:
sensing colors in water around a downrigger probe via a sensor of at least one sensor of the downrigger probe, the at least one sensor coupled to at least one processor of the downrigger probe, the downrigger probe used for fishing;
transforming, by the at least one processor, respective values of the colors sensed by the sensor into an ambient color temperature of the water around the downrigger probe; and
transmitting, by the downrigger probe, the ambient color temperature acoustically through the water.

18. The method of claim 17, wherein the colors sensed are RGB colors, the respective values of the colors are RGB values of the colors sensed, the sensor is a device coupled to the at least one processor of the downrigger probe via a digital bus, and wherein the method further comprises, by the device of the downrigger probe:
sensing ambient light, sensing the RGB colors, performing proximity detection, and generating the RGB values based on the RGB colors sensed; and
transmitting the RGB values to the at least one processor via the digital bus.

19. The method of claim 17, further comprising attaching the downrigger probe to a downrigger line via a line attachment of the downrigger probe and wherein the line attachment is a metal bridle.

20. method of claim 17, wherein the respective values of the colors are RGB values and wherein transforming the respective values of the colors sensed into the ambient color temperature includes:
converting the RGB values to Commission Internationale de l′Elcairage (CIE) tristimulus values;
computing normalized chromaticity values based on the CIE tristimulus values; and
computing the ambient color temperature based on the normalized chromaticity values computed, wherein the ambient color temperature computed is expressed in Kelvin.

21. The method of claim 17, further comprising:
by the at least one processor, generating an electrical signal representing the ambient color temperature;
by a power amplifier stage of the downrigger probe, amplifying the electrical signal generated;
by a piezoceramic element of the downrigger probe, transforming the electrical signal generated and amplified into an acoustic signal; and
by the downrigger probe, transmitting the acoustic signal to transmit the ambient color temperature, acoustically, through the water.

22. The method of claim 17, wherein the sensor is a color-and-proximity sensor and wherein the method further comprises:
by the color-and-proximity sensor, emitting light, sensing reflected light that is reflected in response to the light emitted, and outputting a proximity measurement based on the reflected light sensed, wherein the proximity measurement is affected by particles in the water and includes a near proximity measurement and a far proximity measurement;
by the at least one processor, determining a level of turbidity in the water based on the near proximity measurement and the far proximity measurement and generating an electrical signal representing the level of turbidity determined;
by a power amplifier stage of the downrigger probe, amplifying the electrical signal generated;
by a piezoceramic element of the downrigger probe, transforming the electrical signal generated and amplified into an acoustic signal; and
by the downrigger probe, transmitting the acoustic signal to transmit, acoustically through the water, the level of turbidity determined.

23. The method of claim 17, wherein the at least one sensor further includes a Hall effect sensor, and wherein the method further comprises:
by the Hall effect sensor, sensing magnetic field changes generated by rotation of a magnetic paddlewheel of the downrigger probe and outputting a Hall effect sensor signal based on the magnetic field changes sensed; and
by the at least one processor, determining a speed of the water around the downrigger probe based on the Hall effect sensor signal output and transmitting, acoustically through the water, the speed determined.

24. The method of claim 23, wherein a frequency of the Hall effect sensor signal output is based on a rotation speed of the magnetic paddlewheel, wherein the rotation speed is affected by the speed of the water, and wherein the method further comprises:
by the at least one processor, determining the frequency of the Hall effect sensor signal output, wherein determining the speed of the water is based on the frequency determined and a conversion coefficient for the downrigger probe.

25. The method of claim 24, wherein at least one memory is coupled to the at least one processor, wherein the at least one memory includes a lookup table, and wherein the method further comprises:
by an inertial measurement unit (IMU) sensor of the downrigger probe, measuring a tilt angle of the downrigger probe; and
by the at least one processor, selecting the conversion coefficient from the lookup table based on the tilt angle measured and determining the speed of the water based on the frequency determined and the conversion coefficient selected.

26. method of claim 23, further comprising:
by the at least one processor, generating an electrical signal based on the speed determined;
by a power amplifier of the downrigger probe, amplifying the electrical signal generated;
by a piezoceramic element of the downrigger probe, transforming the electrical signal generated and amplified into an acoustic signal; and
by the downrigger probe, transmitting the acoustic signal to transmit, acoustically through the water, the speed determined.

27. The method of claim 17, wherein the at least one sensor further includes a pressure sensor and wherein the method further comprises:
by the pressure sensor, sensing pressure applied to the downrigger probe; and
by the at least one processor, changing an operating state of the downrigger probe based on the pressure sensed.

28. The method of claim 27, further comprising, by the at least one processor:
causing the downrigger probe to stop transmitting data, acoustically, and to enter a standby state that limits processing to reduce power consumption in an event the pressure sensed is below a first threshold; and
causing the downrigger probe to change the operating state from the standby state to an active state in which acoustic transmission is enabled and processing is not limited in an event the pressure sensed is greater than a second threshold.

29. The method of claim 17, further comprising:
by the at least one processor, configuring a configurable uplink frequency parameter for an acoustic link based on configuration information input to the downrigger probe; and
by the downrigger probe, transmitting the ambient color temperature via the acoustic link based on the configurable uplink frequency parameter configured.

30. The method of claim 17, wherein the at least one sensor further includes a temperature sensor and wherein the method further comprises:
by the temperature sensor, sensing water temperature of the water around the downrigger probe; and
by the downrigger probe, transmitting acoustically through the water, the water temperature sensed.

31. The method of claim 17, further comprising charging a battery of the downrigger probe, wirelessly, via a charging coil of the downrigger probe.

32. A system for fishing, the system comprising:
a downrigger probe fixed on a downrigger line being trolled by a vessel; and
a processor box configured to communicate with the downrigger probe via a hydrophone, the downrigger probe configured to sense colors in water around the downrigger probe, transform respective values of the colors sensed into an ambient color temperature of the water, and transmit the ambient color temperature acoustically through the water to the processor box via the hydrophone, the processor box configured to cause a representation of the ambient color temperature transmitted to be output to a user device.
